(19) United States
(12) Patent Application Publication
(10) Pub. No.: US 2022/0127472 A1
(43) Pub. Date: Apr. 28, 2022

(54) AQUEOUS CORROSION RESISTANT COATINGS WITH SURFACE-HYDROPHOBIC INORGANIC PARTICLES

(71) Applicant: THE CHEMOURS COMPANY FC, LLC, Wilmington, DE (US)

(72) Inventors: Guobin Shan, Wilmington, DE (US); Michael Patrick Diebold, Wilmington, DE (US)

(21) Appl. No.: 17/571,916

(22) Filed: Jan. 10, 2022

Related U.S. Application Data
(62) Division of application No. 16/449,588, filed on Jun. 24, 2019.
Application No. 16/449,588 is a division of application No. 15/544,012, filed on Jul. 16, 2017.
(60) Provisional application No. 62/105,241, filed on Jan. 20, 2015.

(51) Int. Cl. C09D 5/08; C09D 7/62; C07F 7/08; C09C 1/28; C09C 1/36; C09C 1/40; C09D 133/08

(52) U.S. Cl. CPC C09D 5/084; C09D 7/62; C07F 7/081; C09C 1/28; C08K 9/04; C09C 1/405; C09C 1/407; C09D 133/08; C09C 1/3607

(57) ABSTRACT

Aqueous coating compositions providing enhanced anticorrosive and water-resistant properties. The anticorrosive coating comprises water borne resin, surface-hydrophobic inorganic pigments, and/or surface-hydrophobic inorganic extenders.

### FIELD OF THE INVENTION

This invention relates to the field of polymeric coatings with enhanced anticorrosive properties.

### BACKGROUND

Substrates, such as metals, woods, and cements, come in contact with many corrosive substances including water, salt, oxygen and/or industrial chemicals. For example, rust occurs quickly when metals are stored in humid environments resulting in the failure of metal equipment, rusting of ships, and the failure of buildings and bridges. Anticorrosive coatings are placed on metals to inhibit corrosion. First types of anticorrosive coatings use special alloys, or strong oxidizing agents (such as chromate, nitrite, molybdate, and orthophosphate), so as to passivate metal surfaces and inhibit corrosion. Second types of anticorrosive coatings include electrochemically reactive materials that are applied to metal surfaces enabling sacrificial protection. Third types of anticorrosive coatings use polymers and additives that when applied to a metal surface form barriers preventing water and oxygen from reaching the surface of a metal substrate. Sometimes metal objects are simply designed to inhibit corrosion by having smooth surface that are less likely to be damaged.

Preferred anticorrosion coatings will have 1) great wet/dry adhesion so that the coating stays in contact with a substrate; 2) low conductivity that prevents ion & electron motion in coatings; 3) great barrier effects that reduce the transfer of ions, water, and oxygen through coatings; 4) highly stable polymers that do not break down as a result of environmental stresses such as UV radiation, thermal radiation, and water; and 5) components that are compatible, easy to mix, simplifying the process of making coatings. Inorganic particles are widely used in such polymeric coatings providing multiple functions such as opacity, pigment, color, extender, mechanic intensity, scrub resistance. Most, if not all aqueous coatings incorporate inorganic pigment having hydrophilic surfaces compatible with water to enhance the dispersibility of the inorganic pigment in aqueous coatings but reduce corrosion resistance and water resistance of the coating.

In addition, many corrosion resistant coatings include anticorrosive additives including amines, hydrazines, zinc phosphates, hexavalent chromium, and lead red. However, these inhibitors are expensive and pollute the environment. The applications of these additives are highly regulated by strict environmental regulations. Consequently, a commercial need exists to create better, environmentally friendly corrosion resistant coatings able to protect many surfaces.

### SUMMARY OF INVENTION

An aspect of the present invention provides aqueous compositions containing particles, preferably inorganic pigments, and/or extenders, having hydrophobic surfaces that when applied to a substrate, such as metals or woods, prevents corrosion of the substrate. Specifically, one embodiment of the present invention is a corrosion resistant coating comprising: a water borne resin; water; and one or more particles selected from the group comprising an inorganic particle, extender, and combination thereof; wherein the one or more particle comprises a hydrophobic coating selected from the group consisting of polyols, organosiloxanes, organosilanes, alkylcarboxylic acids, alkylsulfonates, organophosphates, organophosphonates, fluoropolymers and mixtures thereof. The particle preferably comprises a hydrophobic coating selected from the group consisting of at least one organosilicon compound having the formula:

R′ₓSi(R)₄₋ₓ

wherein

R′ is a nonhydrolyzable aliphatic, cycloaliphatic or aromatic group having 8-20 carbon atoms; R is a hydrolyzable group selected from alkoxy, halogen, acetoxy or hydroxy or mixtures thereof; and x=1 to 3; and/or, at least one polysiloxane having the formula:

$${( {R}_{n} {SiO}_{\frac{4 - n}{2}} )}_{m}$$

Wherein R is an organic or inorganic group; n=0-3; and m≥2; or a combination thereof; and/or, at least one organic compound such as polyols, fluoropolymers, alkylcarboxylic acids, alkylsulfonates, organophosphates, organophosphonates and mixtures thereof.

Another aspect of the invention comprises a method of inhibiting corrosion of a substrate comprising the step of providing a corrosion resistant coating comprising: a water borne resin; water; one or more particles selected from the group consisting of inorganic particle, extender, and combinations thereof; wherein the one or more particles comprises a hydrophobic coating selected from the group consisting of polyols, organosiloxanes, organosilanes, alkylcarboxylic acids, alkylsulfonates, organophosphates, organophosphonates, fluoropolymers, and mixtures thereof; applying the corrosion resistant coating to a surface of a substrate; and drying the corrosion resistant coating.

### BRIEF DESCRIPTION OF THE FIGURES

FIG. 1 shows photographs of Aqueous Comparative Example A Slurry (FIG. 1A), and Aqueous Example B Slurry (FIG. 1B) dried on steel panels after incubating in a Singleton Salt Spray Chamber for 240 hours.

FIG. 2 shows electrochemical impedance spectroscopy (EIS) curves of compositions Aqueous Comparative Example A Slurry and Aqueous Example B Slurry on steel panels.

FIG. 3 shows photographs of Aqueous Comparative Example C Slurry (FIG. 3A) and Aqueous Example D Slurry (FIG. 3B) dried on steel panels after incubating in a Singleton Salt Spray Chamber for 672 hours.

FIG. 4 shows photographs of Aqueous Comparative Example E Slurry (FIG. 4A), and Aqueous Example F Slurry (FIG. 4B) dried on steel panels after incubating in a Singleton Salt Spray Chamber for 371 hours.

FIG. 5 is a schematic diagram of the wetting angle 8 measured in Examples G, H, and I.

### DETAILED DESCRIPTION

It is understood that this invention is not limited to particular embodiments, which can, of course, vary. It is also to be understood that the terminology used herein is for the purpose of describing particular embodiments only, and is not intended to be limiting. Further, all publications referred to herein are incorporated by reference herein for the purpose cited to the same extent as if each was specifically and individually indicated to be incorporated by reference herein.

As used in this specification and the appended claims, terms in the singular and the singular forms “a,” “an,” and “the,” for example, include plural referents unless the content clearly dictates otherwise. Thus, for example, reference to “pigment,” “the pigment,” or “a pigment” also includes a plurality of pigments. Use of the term “a pigment” also includes, as a practical matter, many types of that pigment.

Additionally, as used herein, “comprising” is to be interpreted as specifying the presence of the stated features, integers, steps, or components as referred to, but does not preclude the presence or addition of one or more features, integers, steps, or components, or groups thereof. Thus, for example, a sample comprising a dispersant may contain additional dispersants or other components, such as other non-dispersant additives. Additionally, the term “comprising” is intended to include examples encompassed by the terms “consisting essentially of” and “consisting of.” Similarly, the term “consisting essentially of” is intended to include examples encompassed by the term “consisting of.”

### Corrosion Resistant Compositions

The aqueous corrosion resistant compositions of the present invention include inorganic particles having hydrophobic surfaces, which are quite different from most conventional aqueous compositions. Typical aqueous coatings containing inorganic particles comprise inorganic particles having hydrophilic surfaces that like water and are easily dispersible in a mixture of aqueous resin. Inorganic particle surfaces may be coated with silica, zircornia, alumina, or mixtures thereof, to create particles having hydrophilic surfaces. The inorganic particles of the present invention are preferably coated with an organic treatment such as polyols, fluoropolymers, alkylcarboxylic acids, alkylsulfonates, organophosphates, organophosphonates and mixtures thereof, resulting in these particles having hydrophobic surfaces. The preferred hydrophobic coating is selected from the group consisting of at least one organosilicon compound having the formula:

R′ₓSi(R)₄-x
wherein
R′ is a nonhydrolyzable aliphatic, cycloaliphatic or aromatic group having 8-20 carbon atoms; R is a hydrolyzable group selected from alkoxy, halogen, acetoxy or hydroxy or mixtures thereof; and x=1 to 3;
   and/or, at least one polysiloxane having the formula:

$${( {R}_{n} {SiO}_{\frac{4 - n}{2}} )}_{m}$$

Wherein R is an organic or inorganic group; n=0-3; and m≥2; or a combination thereof.

The corrosive preventing coatings of the present invention can be applied to any substrates capable of corroding, such as metal (such as steel), woods, cements, concretes, composites, or a combination thereof. Inorganic particles used in the present invention include inorganic particles and/or extenders, preferable TiO₂ pigment. To form an anticorrosive coating these inorganic particles are mixed with water and one or more water borne resins. The amount of water in these compositions is in the range of 10 to 70 weight percent of the composition, preferably in the range of 20 to 50 weight percent of the composition, most preferably in the range of 20 to 40 weight percent of the composition. It is believed that any water borne resin may be used in the composition of the present invention, but the preferred resin is acrylic.

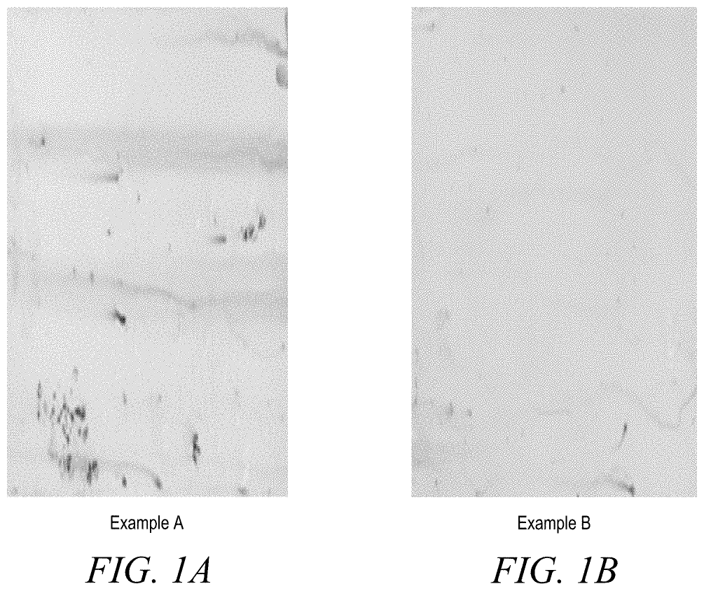

The anti-corrosive properties of compositions of the present invention were demonstrated by coating steel panels with the compositions and placing them in a salt water environment, specifically in a Singleton Salt Spray Chamber, for hundreds of hours. The steel panels were then removed from the salt water environment and the amount of rust on each plate was then studied. For example, one metal panel was coated with aqueous example B slurry according to the present invention comprising 16 wt. % TiO₂ coated with octyltriethoxysilane to form a hydrophobic surface on the TiO₂ particles. Another plate was coated with aqueous comparative example A aqueous slurry comprising 16 wt. % TiO₂ coated with hydrous alumina to form a hydrophilic surface on the TiO₂ particles. Both plates were placed in a Singleton Salt Spray Chamber for 240 hours under the ASTM B117 standard test method. As shown in FIG. 1, the plate coated with the aqueous example B slurry developed less rust than the plate covered with the aqueous comparative example A slurry.

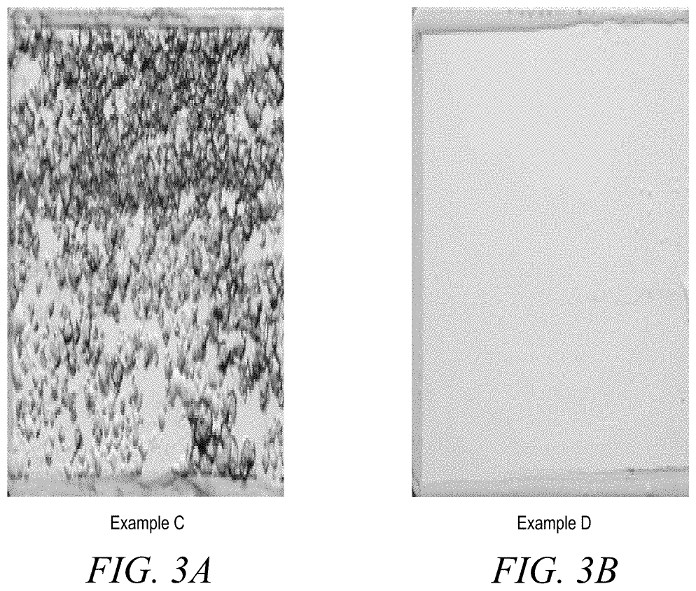

Another test was performed on aqueous comparative example D slurry and aqueous example C slurry by coating steel panels with the compositions and placing them in a salt water environment. One metal plate was coated with aqueous example D slurry of the present invention comprising 27 wt. % TiO₂ coated with octyltriethoxysilane to form a hydrophobic surface. Another metal plate was coated with aqueous comparative example C slurry, an aqueous slurry composition comprising 27 wt. % TiO₂ coated with hydrous alumina to form a hydrophilic surface. Both plates were placed in a Singleton Salt Spray Chamber for 672 hours under the ASTM B117 standard test method. As shown in FIG. 3, the steel panel coated with the aqueous Example D slurry developed less rust than the steel panel covered with the aqueous Example C slurry.

### Inorganic Particles

Inorganic particles used in the corrosion resistant coatings of the present invention include inorganic pigments, extenders, or a combination thereof having inherently hydrophobic surfaces, or surfaces that are coated with an organic layer to create a hydrophobic surface. Some examples of inorganic pigments include, but are not limited to, ZnS, TiO₂, BaSO₄, ZnO, Alumina, Silica, CaCO₃ and MoS₂. Corrosion resistant coatings of the present invention typically include in the range of 5 to 50 weight percent of inorganic particles, more preferably in the range from 10 to 40 weight percent of inorganic particles, and most preferably in the range of 10 to 30 weight percent of inorganic particles.

Hydrophobic is defined herein as water repellent. The term hydrophobic when describing a corrosion resistant coating of the present invention means the surfaces of inorganic particles or part of inorganic particles in the coating are hydrophobic, i.e., the surface of the particle contains hydrophobic components. It is believed that the hydrophobicity of a corrosion resistant coating of the present invention is created by inorganic particles treated with one or more layers of an organic compound having at least one or more nonhydrolyzable aliphatic, cycloalipatic or aromatic group having 8-20 atoms. Inorganic particles used in the present invention may be treated with an organic compound such as polyols, fluoropolymers, organosiloxanes, organosilanes, alkylcarboxylic acids, alkylsulfonates, organophosphates, organophosphonates and mixtures thereof. The organic compound is present at a loading of between 0.1 wt % and 5.0 wt % on a total particle basis. The most preferred organic surface treatment or coating comprises (a) or (b) or a mixture of (a) and (b) wherein

(a) is at least one organosilicon compound having the formula:

R′ₓSi(R)₄₋ₓ

wherein
R′ is a nonhydrolyzable aliphatic, cycloaliphatic or aromatic group having 8-20 carbon atoms;
R is a hydrolyzable group selected from alkoxy, halogen, acetoxy or hydroxy or mixtures thereof; and x=1 to 3; and
(b) is at least one polysiloxane having the formula:

$${( {R}_{n} {SiO}_{\frac{4 - n}{2}} )}_{m}$$

wherein
R is an organic or inorganic group; n=0-3; and m≥2.

In particular, titanium dioxide is an especially useful inorganic pigment in the processes and products of this invention. Titanium dioxide (TiO₂) pigment useful in the present invention may be in the rutile or anatase crystalline form. It is commonly made by either a chloride process or a sulfate process. In the chloride process, TiCl₄ is oxidized to TiO₂ pigments. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference. The pigment may be a pigment or nanoparticle.

The titanium dioxide pigment may be substantially pure titanium dioxide or may contain other components, such as silica, alumina, aluminosilicates, phosphates, and zirconia. These components may become incorporated into the pigments and/or may be coated on the surfaces of the pigments, for example, by an oxidation process and/or a precipitation process. These components may be typically about 0.1 to about 20 wt %, more typically about 0.1 to about 12 wt %, and most typically about 0.5 to about 10 wt %, based on the total pigment weight.

The pigment is washed and filtered to remove salts. The process is done in a rotary filter or a filter press. The filter cake is then dried in a spray or flash drier and the drier discharge is de-agglomerated, such as, in a hammer mill. The pigment is conveyed pneumatically to a fluid energy mill, e.g. micronizer where the final de-agglomeration step is done. The organic treatment can be done by spraying octyltriethoxysilane (neat or as an aqueous solution) at several locations: onto the filter cake before the hammer mill, at the micronizer (main inlet, jet nozzle and/or main outlet). The addition can take place exclusively at one location or at more than one location, simultaneously,

By “pigment” it is meant that the titanium dioxide pigments have an average size of less than 1 micron. Typically, the pigments have an average size of from about 0.020 to about 0.95 microns, more typically from about 0.050 to about 0.75 microns and most typically about 0.075 to about 0.60 microns, as measured by Horiba LA300 Particle Size Analyzer.

The inorganic pigment may have a surface area of about 6 to about 150 m²/g; more typically about 6 to about 30 m²/g; and still more typically about 8 to about 15 m²/g.

Extenders, also called “extender pigments”, are typically inorganic particles having an average size of from about 0.50 to about 20 microns. Not like inorganic pigments, such as TiO₂, extender pigment itself provides little opacity. Extender pigments are added to paints to lower their cost or enhance other properties. Extender pigments include, but are not limited to calcium carbonate, calcium sulfate, silica, aluminosilicates, talc, and clays.

### Properties of Particles with Hydrophobic Surfaces

An aqueous composition comprising 10% to 50% water including a high concentration of particles having hydrophobic surfaces was prepared and then dried on surfaces to protect these surfaces from corrosion as illustrated in FIGS. 1-4.

### Coating Compositions

The compositions of the present invention may include a mixture of water borne resin, inorganic particles, and other additives known to one skilled in the art.

### Resins

The resin is selected from the group consisting of water-dispersible (or water borne) resin such as latex (acrylic); vinyl-acrylic; epoxy; alkyd; urethanes; and unsaturated polyesters; and mixture thereof. By “anti-corrosive composition” or “corrosion resistant” as used herein is meant surface coatings intended for the protection against corrosion and/or decoration of a substrate, comprising essentially an emulsion, latex, or a suspension of a film-forming material dispersed in an aqueous phase, and typically comprising surfactants, protective colloids and thickeners, pigments and extender pigments, preservatives, fungicides, freeze-thaw stabilizers, antifoam agents, agents to control pH, coalescing aids, and other ingredients. A water-dispersed coating may be exemplified by, but not limited to, pigmented coatings such as latex paints. For latex paints the film forming material is a latex polymer of acrylic, styrene-acrylic, vinyl-acrylic, ethylene-vinyl acetate, vinyl acetate, alkyd, vinyl chloride, styrene-butadiene, vinyl versatate, vinyl acetate-maleate, or a mixture thereof. Such water-dispersed coating compositions are described by C. R. Martens in “Emulsion and Water-Soluble Paints and Coatings” (Reinhold Publishing Corporation, New York, N.Y., 1965). Tex-Cote® and Super-Cote®, Rhopelx®, Vinnapas® EF500 are further examples of water based coating compositions comprising 100% acrylic resin.

The alkyd resins may be complex branched and cross-linked polyesters having unsaturated aliphatic acid residues. Urethane resins typically comprise the reaction product of a polyisocyanate, usually toluene diisocyanate, and a polyhydric alcohol ester of drying oil acids.

The resin can be present in the amount of about 50 to about 95% by weight based on the total weight of the coating composition. The amount of resin is varied depending on the amount of gloss finish desired.

### Colorant

The treated particles, including inorganic pigments, particularly the treated titanium dioxide pigments described earlier may be used alone or in combination with conventional colorants. Any conventional colorant such as a pigment, dye or a dispersed dye may be used in this disclosure to impart color to the coating composition. In one embodiment, generally, about 0.1% to about 40% by weight of conventional pigments, based on the total weight of the component solids, can be added. More typically, about 0.1% to about 25% by weight of conventional pigments, based on the total weight of component solids, can be added.

The pigment component of this invention may be any of the generally well-known pigments or mixtures thereof used in coating formulations, as reported, e.g., in Pigment Handbook, T. C. Patton, Ed., Wiley-Interscience, New York, 1973. Any of the conventional pigments used in coating compositions can be utilized in these compositions such as the following: metallic oxides, such as titanium dioxide, zinc oxide, and iron oxide, metal hydroxide, metal flakes, such as aluminum flake, chromates, such as lead chromate, sulfides, sulfates, carbonates, carbon black, silica, talc, china clay, phthalocyanine blues and greens, organo reds, organo maroons, pearlescent pigments and other organic pigments and dyes. If desired chromate-free pigments, such as barium metaborate, zinc phosphate, aluminum triphosphate and mixtures thereof, can also be used.

### Other Additives

A wide variety of additives may be present in the coating compositions of this invention as necessary, desirable or conventional. These compositions can further comprise various conventional paint additives, such as dispersing aids, anti-settling aids, wetting aids, thickening agents, extenders, plasticizers, stabilizers, light stabilizers, antifoams, defoamers, catalysts, texture-improving agents and/or antiflocculating agents. Conventional paint additives are well known and are described, for example, in “C-209 Additives for Paints” by George Innes, February 1998, the disclosure of which is incorporated herein by reference. The amounts of such additives are routinely optimized by the ordinary skilled artisan so as to achieve desired properties in the paint, such as thickness, texture, handling, and fluidity.

Coating compositions of the present invention may comprise various rheology modifiers or rheology additives (such as Acrysol®), wetting agents, dispersants and/or co-dispersants, and microbicides and/or fungicides. To achieve enhanced weatherability, the present coating compositions may further comprise UV (ultra-violet) absorbers such as Tinuvin®.

Coating compositions of the present invention may further comprise at least one solvent. Suitable solvents can be solvents having an octanol-water partition coefficient of 1 to 5. The octanol/water partition coefficient is defined as the ratio of a chemical's concentration in the octanol phase to its concentration in the aqueous phase of a two-phase octanol/water system at equilibrium. Such solvents can include, for example, ketones, alcohols, esters and ethers of alcohols, aromatics, glycol ethers and esters. In an aspect of the invention such solvents can include, for example, propylene glycol n-butyl ether, dipropylene glycol n-butyl ether, tripropylene glycol n-butyl ether, 2,2,4-trimethylpentane-1,3-diol monoisobutyrate, butanol, hexanol, pentanol, octanol, 2-ethyl-1-butanol, 2-methyl-1-pentanol, 2-butoxyethanol, 2,2,4-trimethyl-1,3-pentanediol mono (2-methylpropanoate), diethylene glycol n-butyl ether acetate, diethylene glycol n-butyl ether acetate, propylene glycol phenyl ether, ethylene glycol phenyl ether, isobutyl isobutyrate, methyl isobutyl ketone, methyl ethyl ketone, 1-methoxy-2-propyl acetate (propylene glycol monomethyl ether acetate), dioctyl phthalate.

Coating compositions of the present invention may further comprise ceramic or elastomeric substances, which are heat and/or infrared reflective, so as to provide additional heat reflective benefits.

### Preparation of Coating Compositions

The present invention provides a process for preparing a coating composition, such as a paint formulation, comprising mixing the inorganic particles, including pigment-containing components with the resin to form a coating base. A vehicle such as water is present typically in the range from 10 to 70 weight percent of a composition, preferably in the range of 10 to 50 weight percent of a composition, more preferably in the range of 20 to 40 weight percent of a corrosion resistant coating of the present invention. Typically these coating compositions may comprise from about 30 to about 55% solids by weight and typically about 25% to about 45% solids by volume. Typically the coating compositions of this invention have a density of about 9.1 to about 11.9 pounds per gallon, more typically about 9.5 to about 10.8 pounds per gallon. Any mixing means known to one skilled in the art may be used to accomplish this mixing. An example of a mixing device includes a high speed Dispermat®, supplied by BYK-Gardner, Columbia, Md.

Corrosion resistant coatings of the present invention may be applied by any means known to one skilled in the art, for example, by brush, roller, commercial grade airless sprayers, or electrostatically in a particle coating. Coating compositions presented herein may be applied as many times necessary so as to achieve sufficient coating on a surface, for example, an exterior wall, metal substrate, wood substrate, paper substrate, and/or plastic substrate. Typically, these coating compositions may be applied from about 2 mils to about 10 mils wet film thickness, which is equivalent to from about 1 to about 5 dry mils film thickness. Coating compositions presented herein may be applied directly to surfaces or applied after surfaces are first coated with primers as known to one skilled in the art. The compositions of this invention may be a paint, and the paint may be applied to a surface selected from the group including of metals, woods, bridges, boats, cars, and buildings. The compositions of the present invention dry on the surface of a substrate to form an anticorrosive coating. The anticorrosive coatings of the present invention without the addition of anticorrosive additives such as amines, hydrazine, zinc phosphates, hexavalent chromium, and lead red, have a corrosive resistance of greater than 1×10⁷ Ohms, preferably greater than 1×10⁸ Ohms, and more preferably greater than 1×10⁹ Ohms as measured by an Electrochemical impedance spectroscopy. It is believe that corrosion resistant coatings of the present invention including anticorrosive additives may have even greater corrosive resistance.

### Definitions

“Tamol-165”: a dispersant, ammonium salt of a hydrophobic copolymer, manufactured by DOW Chemicals.

“Tamol-681”: a dispersant, ammonium salt of a hydrophobic copolymer, manufactured by DOW Chemicals.

“Triton CF-10”: a nonionic surfactant, benzyl-polyethylene glycol, manufactured by DOW Chemicals.

“Maincote HG-54D”: water-borne acrylic resin suspension, manufactured by DOW Chemicals.

“Maincote HG-31”: water-borne acrylic resin suspension, manufactured by DOW Chemicals.

“Tego Foamex 1488”: defoamer, an emulsion of a polyether siloxane copolymer, contains fumed silica, manufactured by Evonik Industries.

“Capstone FS-61”: ammonia salt of fluorinated compound, manufactured by DuPont.

“DPM”: Dipropylene glycol methyl ether, a coalescent, manufactured by DOW Chemicals.

“Corrosion or Corrosive” means causing damage to metal or other materials through a chemical process such as oxidation and/or salt related chemical reactions.

“Anti-corrosive” or “corrosion resistant” means to prevent damage to metal or other materials through a chemical process such as oxidation and/or salt related chemical reactions.

“Water-resistant” means objects relatively unaffected by water or resisting the ingress of water.

### EXAMPLES

### Comparative Example A

Aqueous Comparative Example A Slurry was prepared by mixing the components of Table 1 by conventional methods.

TABLE 1
Composition of Comparative Example A Slurry

| Components | Weight (gram) |
|---|---|
| Rutile TiO₂ pigment coated | 97.5 |
| with silica and then with | |
| hydrous alumina to form a | |
| hydrophilic surface having a | |
| medium particle size of 0.36 um. | |
| Tamol-165 | 4.8 |
| Ammonia (28 wt %) | 2.5 |
| Triton CF-10 or Capstone FS-61 | 0.75 |
| Water | 20 |
| Butyl cellosolve | 55 |
| DPM | 9 |
| Maincote HG-54D | 330 |
| Tego Foamex 1488 | 1.95 |
| Sodium nitrite (15 wt %) | 4.5 |

### Example B

Aqueous Example B Slurry was prepared by mixing Table 2 components by conventional methods.

TABLE 2
Composition of Example B Slurry of the Present Invention

| Components | Weight (gram) |
|---|---|
| Rutile TiO₂ pigment coated | 97.5 |
| with octyltriethoxysilane to | |
| form a hydrophobic surface | |
| having a mean particle size | |
| of 0.23 uM. | |
| Tamol-165 | 4.8 |
| Ammonia (28 wt %) | 2.5 |
| Triton CF-10 or Capstone FS-61 | 0.75 |
| Water | 20 |
| Butyl cellosolve | 55 |
| DPM | 9 |
| Maincote HG-54D | 330 |
| Tego Foamex 1488 | 1.95 |
| Sodium nitrite (15 wt %) | 4.5 |

### Determination of Anticorrosion Property of Compositions of Examples a and B

Anticorrosion properties of Aqueous Comparative Example A Slurry and Aqueous Example B Slurry were determined using a Singleton Salt Spray Chamber. The Singleton Salt Spray was used under the following conditions: Condensation Rate: 2 ml. per hour; Humidifier Temperature: 118° F.; Tank Temperature: 95° F.; Solution: 5% Sodium Chloride; Test Duration: 240 hours; and sample edges were coated with candle wax to cover any uncoated metal on the edges. FIG. 1 illustrates Aqueous Example B Slurry including inorganic particles with hydrophobic surfaces (FIG. 1B) provided much better anti-corrosion protection then Aqueous Comparative Example A Slurry including inorganic particles having hydrophilic surfaces (FIG. 1A).

### Determination of Anticorrosion Properties of Examples a and B

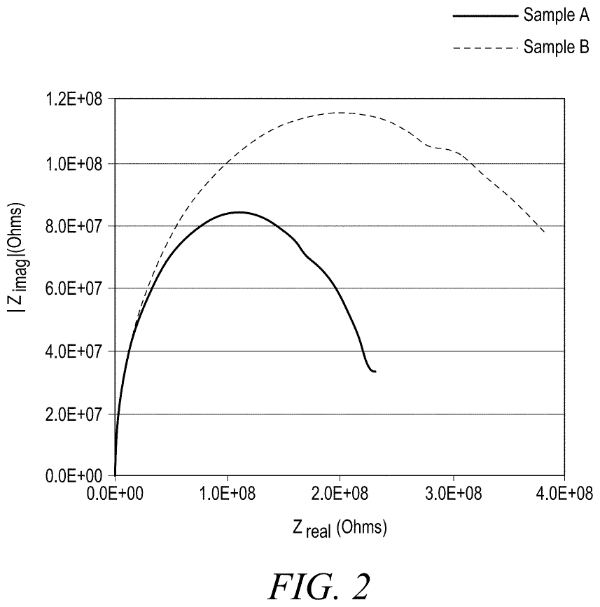

Electrochemical impedance spectroscopy (EIS) was also used to evaluate anti-corrosion property of Aqueous Comparative Example A Slurry and Aqueous Example B Slurry. The EIS was used at room temperature with 3% NaCl and data was collected as shown in Table 3. Aqueous Example B Slurry, a composition including an inorganic pigment having a hydrophobic surface provided greater anti-corrosion protection than Aqueous Comparative Example A Slurry including an inorganic pigment having a hydrophilic surface. FIG. 2 shows that Aqueous Example B Slurry, a composition including an inorganic pigment having a hydrophobic surface, gives greater anti-corrosion protection than Aqueous Comparative Example A Slurry, a composition including an organic pigment having a hydrophilic surface.

TABLE 3
Comparison of EIS Results of Examples A and B

| | Corrosion | Corrosion | |
|---|---|---|---|
| | potential | Resistance | R (0.01Hz)-R (100Hz) |
| Samples | Ecor (V vs SCE) | Rp (Ohms) | (Ohms) |
| A | −0.439 | 1.4 × 10⁶ | 7.0 × 10⁵ |
| B | +0.382 | 1.3 × 10⁹ | 1.3 × 10⁹ |

### Comparative Example C

Aqueous Comparative Example C Slurry was prepared by mixing the components of Table 4 by conventional methods.

TABLE 4
Components of Example C

| Components | Weight (gram) |
|---|---|
| Rutile TiO₂ pigment coated | 390 |
| with silica and then with | |
| hydrous alumina to form a | |
| hydrophilic surface having a | |
| medium particle size of 0.36 | |
| um. | |
| Tamol-165 | 19 |
| Ammonia (28 wt %) | 5 |
| Triton CF-10 | 1.5 |
| Water | 35 |
| Butyl cellosolve | 110 |
| DPM | 18 |
| Maincote HG-54D | 660 |
| Tego Foamex 1488 | 4 |
| Sodium nitrite (15 wt %) | 9 |

### Example D

Aqueous Example D Slurry was prepared by mixing the components in Table 5 by conventional methods.

TABLE 5
Components of Example D

| Components | Weight (gram) |
|---|---|
| Rutile TiO₂ pigment coated | 390 |
| with octyltriethoxysilane to | |
| form a hydrophobic surface | |
| having a mean particle size | |
| of 0.23 uM. | |
| Tamol-165 | 19 |
| Ammonia (28 wt %) | 5 |
| Triton CF-10 | 1.5 |
| Water | 35 |
| Butyl cellosolve | 110 |
| DPM | 18 |
| Maincote HG-54D | 660 |
| Tego Foamex 1488 | 4 |
| Sodium nitrite (15 wt %) | 9 |

### Determination of Anticorrosion of Aqueous Comparative Examples C Slurry and Aqueous Example D Slurry

Anticorrosion properties of coatings were determined using a Singleton Salt Spray Chamber under the following conditions: Condensation Rate: 2 ml. per hour; Humidifier Temperature: 118° F.; Tank Temperature: 95° F.; Solution: 5% Sodium Chloride; Test Duration: 240 hours; and sample edges were coated with candle wax to cover any uncoated metal on the edges. FIG. 3 shows that Aqueous Example D Slurry including an inorganic pigment having a hydrophobic surface (FIG. 3B) exhibits a greater anti-corrosion performance than Aqueous Comparative Example C including an organic pigment having a hydrophilic surface (FIG. 3A) when incubated in a Singleton Salt Spray Chamber for 672 hours.

### Comparative Example E

Aqueous Comparative Example E Slurry was prepared by mixing the components of Table 6 by conventional methods.

TABLE 6
Components of Example E

| | Weight |
|---|---|
| Components | (gram) |
| Rutile TiO₂ pigment coated with | 220 |
| silica and then with hydrous | |
| alumina to form a hydrophilic | |
| surface having a medium particle | |
| size of 0.36 um. | |
| Tamol-681 | 9.43 |
| Ammonia (28 wt %) | 2 |
| Ammonia (15 wt %) | 7 |
| Surfynol 104DPM | 4 |
| Water | 102 |
| Dowanol DPM | 16 |
| T exanol | 48.6 |
| Maincote HG-31 | 600 |
| Tego Foamex 825 | 1 |
| ACRYSOL RM-8W | 2 |
| Sodium nitrite (15 wt %) | 9 |

### Example F

Aqueous Example F Slurry was prepared by mixing the components in Table 7 by conventional methods.

TABLE 7
Components of Example F

| Components | Weight (gram) |
|---|---|
| Rutile TiO₂ pigment coated with silica and | 220 |
| alumina and then coated with | |
| octyltriethoxysilane to form a hydrophobic | |
| surface having a mean particle size of 0.36 um. | |
| Tamol-681 | 9.43 |
| Ammonia (28 wt %) | 2 |
| Ammonia (15 wt %) | 7 |
| Surfynol 104DPM | 4 |
| Water | 102 |
| Dowanol DPM | 16 |
| Texanol | 48.6 |
| Maincote HG-31 | 600 |
| Tego Foamex 825 | 1 |
| ACRYSOL RM-8W | 2 |
| Sodium nitrite (15 wt %) | 9 |

### Determination of Anticorrosion of Aqueous Comparative Examples E Slurry and Aqueous Example F Slurry

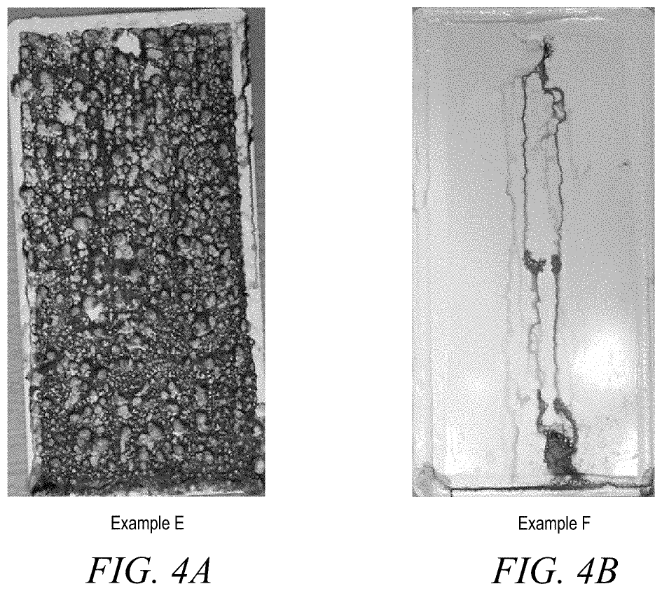

Anticorrosion properties of coatings were determined using a Singleton Salt Spray Chamber under the following conditions: Condensation Rate: 2 ml. per hour; Humidifier Temperature: 118° F.; Tank Temperature: 95° F.; Solution: 5% Sodium Chloride; Test Duration: 371 hours; and sample edges were coated with candle wax to cover any uncoated metal on the edges. FIG. 4 shows that Aqueous Example F Slurry including an inorganic pigment having a hydrophobic surface (FIG. 4B) exhibits a greater anti-corrosion performance than Aqueous Comparative Example E including an organic pigment having a hydrophilic surface (FIG. 4A) when incubated in a Singleton Salt Spray Chamber for 672 hours.

### Comparative Example G

Titanium dioxide particles were made by the vapor phase oxidation process of titanium tetrachloride and the surface of titanium dioxide particles was treated with silica and alumina. 200 grams of the silica/alumina-treated TiO2 powder was mixed with 5.5 mmol of triethoxy(ethyl)silane in 150 g of ethanol for 10 minutes. The ethanol was removed and the powder was dried in an oven at 110° C. for 4 hours to obtain comparative example G.

### Example H

Titanium dioxide particles were made by the vapor phase oxidation process of titanium tetrachloride and the surface of titanium dioxide particles was treated with silica and alumina. 200 grams of the silica/alumina-treated TiO2 powder was mixed with 5.5 mmol of triethoxy(octyl)silane in 150 g of ethanol for 10 minutes. The ethanol was removed and the powder was dried in an oven at 110° C. for 4 hours to obtain example H.

### Example I

Titanium dioxide particles were made by the vapor phase oxidation process of titanium tetrachloride and the surface of titanium dioxide particles was treated with silica and alumina. 200 grams of the silica/alumina-treated TiO2 powder was mixed with 5.5 mmol of triethoxy(dodecyl)silane in 400 g of ethanol for 10 minutes. The ethanol was removed and the powder was dried in an oven at 110° C. for 4 hours to obtain example I.

The relative hydrophobicity of each example was determined by measuring the water contact angle (WCA). The WCA is the angle, where a liquid/vapor interface meets a solid surface. In this case, the liquid is water and the vapor is air.

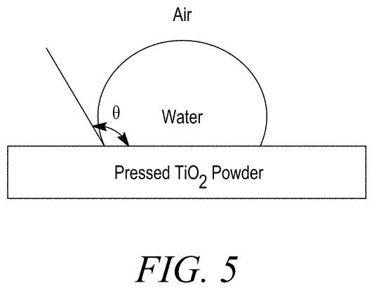

Samples of the treated TiO2 from Examples G, H, and I were pressed on a sample holder to create a flat surface. A drop of water was then placed on the sample surface and the WCA was measured on the surface. Two measurements were obtained for each Example. A schematic diagram demonstrating the WCA measurement is shown in FIG. 5. Generally, if the WCA is less than 90°, the surface is considered hydrophilic; and if the water contact angle is larger than 90°, the surface is considered hydrophobic.

From the below data it can be seen that samples prepared according to a preferred aspect of the invention are more hydrophobic than the comparative sample.

TABLE 8

| | | | WCA | WCA | WCA |
|---|---|---|---|---|---|
| Example It | Pigment Base | Surface Treatment | Measurement 1 | Measurement 2 | Avg. |
| Comparative | Alumina/silica | Triethoxy(ethyl)silane | 0° | 0° | 0° |
| Example G | coated TiO₂ powder | | | | |
| Example H | Alumina/silica | Triethoxy(octyl)silane | 117.2° | 120.8° | 119° |
| | coated TiO₂ powder | | | | |
| Example 1 | Alumina/silica | Triethoxy | 131.5° | 127.8° | 129.7° |
| | coated TiO₂ powder | (dodecyl)silane | | | |

What is claimed is:

1. A corrosion resistant coating comprising:
a. a water borne resin;
b. water; and
c. one or more particles selected from the group comprising an inorganic particle, extender, and combination thereof; wherein the one or more particle comprises a hydrophobic coating selected from the group consisting of polyols, organosiloxanes, organosilanes, alkylcarboxylic acids, alkylsulfonates, organophosphates, organophosphonates, fluoropolymers and mixtures thereof.

2. A corrosion resistant coating comprising:
a. water borne resin;
b. water;
c. one or more particles selected from the group comprising an inorganic particle, extender, and combination thereof; wherein the one or more particle comprises a hydrophobic coating selected from the group consisting of polyols, organosiloxanes, organosilanes, alkylcarboxylic acids, alkylsulfonates, organophosphates, organophosphonates, fluoropolymers and mixtures thereof; and
d. at least one solvent.

3. The corrosion resistant coating of claim 1 wherein the hydrophobic coating reduces corrosion and water penetration ability.

4. The corrosion resistant coating of claim 2 wherein the hydrophobic coating reduces corrosion and water penetration ability.

5. The corrosion resistant coating of claim 2 wherein the at least one solvent comprise a solvent having an octanol-water partition coefficient of 1 to 5.

6. The corrosion resistant coating of claim 2 wherein the at least one solvent is selected from the group consisting of ketones, alcohols, esters and ethers of alcohols, aromatics, glycol ethers and esters.

7. The corrosion resistant coating of claim 2 wherein the at least one solvent is selected from the group consisting of propylene glycol n-butyl ether, dipropylene glycol n-butyl ether, tripropylene glycol n-butyl ether, 2,2,4-trimethylpentane-1,3-diol monoisobutyrate, butanol, hexanol, pentanol, octanol, 2-ethyl-1-butanol, 2-methyl-1-pentanol, 2-butoxyethanol, 2,2,4-trimethyl-1,3-pentanediol mono (2-methylpropanoate), diethylene glycol n-butyl ether acetate, diethylene glycol n-butyl ether acetate, propylene glycol phenyl ether, ethylene glycol phenyl ether, isobutyl isobutyrate, methyl isobutyl ketone, methyl ethyl ketone, 1-methoxy-2-propyl acetate (propylene glycol monomethyl ether acetate), and dioctyl phthalate.

8. The corrosion resistant coating of claim 1 wherein the hydrophobic coating is in the range of 0.1 to 5 percent by weight of the one or more particles.

9. The corrosion resistant coating of claim 1 wherein the one or more particles is in the range of 5 to 50 percent by volume of the coating.

10. The corrosion resistant coating of claim 1 wherein the hydrophobic coating is an organosilane.

11. The corrosion resistant coating of claim 4 wherein the hydrophobic coating is at least one organosilane having the formula:
R′ₓSi(R)₄₋ₓ
wherein R′ is a nonhydrolyzable aliphatic, cycloaliphatic or aromatic group having 8-20 carbon atoms; R is a hydrolyzable group selected from alkoxy, halogen, acetoxy or hydroxy or mixtures thereof; and x=1 to 3; and/or at least one polysiloxane having the formula:
$${( {R}_{n} {SiO}_{\frac{4 - n}{2}} )}_{m}$$
wherein R is an organic or inorganic group; n=0-3; and m≥2; or a combination thereof

12. The corrosion resistant coating of claim 1 wherein the one or more particles are inorganic particles.

13. The corrosion resistant coating of claim 1, wherein the one or more particles are titanium dioxide.

14. The corrosion resistant coating of claim 1, wherein the one or more particles are silicon dioxide.

15. The corrosion resistant coating of claim 1, wherein the one or more particles are aluminum oxide.

16. The corrosion resistant coating of claim 1, wherein the one or more particles are aluminosilicates.

17. The corrosion resistant coating of claim 1 wherein the one or more particles is an extender.

18. The corrosion resistant coating of claim 1 further comprising a dispersant.

19. The corrosion resistant coating of claim 1, further comprising a water borne resin selected from the group consisting of acrylic, alkyd, urethanes, epoxy, unsaturated polyesters, and mixtures thereof.

20. The corrosion resistant coating of claim 1, wherein the water borne resin is acrylic.

21. The corrosion resistant coating of claim 16, wherein the acrylic is selected from the group consisting of styrene-acrylic, vinyl-acrylic, ethylene-vinyl acetate, vinyl acetate, alkyd, vinyl chloride, styrene-butadiene, vinyl versatate, vinyl acetate-maleate, and mixtures thereof.

22. The corrosion resistant coating of claim 1, wherein the water borne resin is present in the range of 50 to 95 percent by volume of the corrosion resistant coating.

23. The corrosion resistant coating of claim 1, wherein the corrosion resistant coating has a corrosive resistance of greater than 1×10⁷ Ohms as measured by an Electrochemical Impedance Spectroscopy.

24. The corrosion resistant coating of claim 1, wherein the corrosion resistant coating has a corrosion resistant of greater than 1×10⁸ Ohms as measured by an Electronic Impedance Spectroscopy.

25. The corrosion resistant coating of claim 1, wherein the one or more particles has a coating of metal oxides, or silica, or phosphates, or metal silicates, or mixtures thereof, located between the one or more particle surface and the hydrophobic coating.

26. A method of inhibiting corrosion of a substrate comprising the step of:
a. providing a corrosion resistant coating comprising:
i) a water borne resin;
ii) water;
iii) one or more particles selected from the group comprising an inorganic particle, extender, and combination thereof; wherein the one or more particle comprises a hydrophobic coating selected from the group consisting of polyols, organosiloxanes, organosilanes, alkylcarboxylic acids, alkylsulfonates, organophosphates, organophosphonates, fluoropolymers, and mixtures thereof;
b. applying the corrosion resistant coating to a surface of a substrate; and
c. drying the corrosion resistant coating.

27. A method of inhibiting corrosion of a substrate comprising the step of:
a. providing a corrosion resistant coating comprising:
i) a water borne resin;
ii) water;
iii) one or more particles selected from the group comprising an inorganic particle, extender, and combination thereof; wherein the one or more particle comprises a hydrophobic coating selected from the group consisting of polyols, organosiloxanes, organosilanes, alkylcarboxylic acids, alkylsulfonates, organophosphates, organophosphonates, fluoropolymers, and mixtures thereof;
iv) at least one solvent;
c. applying the corrosion resistant coating to a surface of a substrate; and
d. drying the corrosion resistant coating.

28. The method of inhibiting corrosion of claim 26, wherein the substrate is metal.

29. The method of inhibiting corrosion of claim 26, wherein the substrate is steel.

30. The method of inhibiting corrosion of claim 26, wherein the substrate is concrete.

31. The method of inhibiting corrosion of claim 26, wherein the substrate is wood.

32. The method of inhibiting corrosion of claim 26, wherein the one or more particles is titanium dioxide.

33. The method of inhibiting corrosion of claim 26, wherein the corrosion resistant coating has a corrosive resistance of greater than 1×10⁷ Ohms as measured by an Electrochemical Impedance Spectroscopy.

34. The method of inhibiting corrosion of claim 26, wherein the one or more particles is an extender.

35. The method of inhibiting corrosion of claim 26, wherein the corrosion resistant coating further comprises a dispersant.

36. The method of inhibiting corrosion of claim 26, wherein the hydrophobic coating is an organosilane.

37. The method of inhibiting corrosion of claim 26, wherein the hydrophobic coating is at least one organosilane having the formula:
R′ₓSi(R)₄₋ₓ
wherein R′ is a nonhydrolyzable aliphatic, cycloaliphatic or aromatic group having 8-20 carbon atoms; R is a hydrolyzable group selected from alkoxy, halogen, acetoxy or hydroxy or mixtures thereof; and x=1 to 3; and/or at least one polysiloxane having the formula:
$${( {R}_{n} {SiO}_{\frac{4 - n}{2}} )}_{m}$$
wherein R is an organic or inorganic group; n=0-3; and m≥2; or a combination thereof

38. The corrosion resistant coating of claim 27 wherein the at least one solvent is selected from the group consisting of ketones, alcohols, esters and ethers of alcohols, aromatics, glycol ethers and esters.

39. The corrosion resistant coating of claim 27 wherein the at least one solvent is selected from the group consisting of propylene glycol n-butyl ether, dipropylene glycol n-butyl ether, tripropylene glycol n-butyl ether, 2,2,4-trimethylpentane-1,3-diol monoisobutyrate, butanol, hexanol, pentanol, octanol, 2-ethyl-1-butanol, 2-methyl-1-pentanol, 2-butoxyethanol, 2,2,4-trimethyl-1,3-pentanediol mono (2-methylpropanoate), diethylene glycol n-butyl ether acetate, diethylene glycol n-butyl ether acetate, propylene glycol phenyl ether, ethylene glycol phenyl ether, isobutyl isobutyrate, methyl isobutyl ketone, methyl ethyl ketone, 1-methoxy-2-propyl acetate (propylene glycol monomethyl ether acetate), and dioctyl phthalate.

40. The method of inhibiting corrosion of claim 27, wherein the corrosion resistant coating has a corrosive resistance of greater than 1×107 Ohms as measured by an Electrochemical Impedance Spectroscopy.
